(19) United States
(12) Patent Application Publication
(10) Pub. No.: US 2014/0172658 A1
(43) Pub. Date: Jun. 19, 2014

(54) VOLUME-RATE FOOD-WASTE DISPOSAL APPARATUS AND CHARGING APPARATUS FOR USE WITH THE SAME

(71) Applicant: Electronics and Telecommunications Research Institute, Daejeon (KR)

(72) Inventors: In Kui CHO, Daejeon (KR); Je Hoon YUN, Daejeon (KR); Seong-Min KIM, Daejeon (KR); Jung Ick MOON, Daejeon (KR); Woo Jin BYUN, Daejeon (KR); Jae Ick CHOI, Daejeon (KR)

(73) Assignee: Electronics and Telecommunications Research Institute, Daejeon (KR)

(21) Appl. No.: 13/909,431

(22) Filed: Jun. 4, 2013

(30) Foreign Application Priority Data
Dec. 14, 2012 (KR) 10-2012-0146488

(51) Int. Cl. G06Q 20/14; G06Q 10/00; G06Q 30/04

(52) U.S. Cl. CPC G06Q 20/145; G06Q 30/04; G06Q 10/30
USPC 705/34

(57) ABSTRACT

A volume-rate food-waste disposal apparatus recognizes a user who discharges food-waste into the food-waste disposal apparatus to produce source information and weights the food-waste to produce weight information. The food-waste disposal apparatus receives an electrical power in a wireless manner and dries the food-waste using magnetic waves. The food-waste disposal apparatus transmits the source information and the source information to a charging server so that an on-line food-waste disposal fee per source is billed on a basis of a prefixed food-waste disposal fee per weight.

### RELATED APPLICATIONS

This application claims the benefit of Korean Patent Application No. 10-2012-0146488, filed on Dec. 14, 2012, which are hereby incorporated by reference as if fully set forth herein.

### FIELD OF THE INVENTION

The present invention relates to a volume-rate garbage disposal system and a charging method thereof. More particularly, the present invention relates to a volume-rate food-waste disposal apparatus which quickly dries food-waste with a wireless power and provides an on-line charging service.

### BACKGROUND OF THE INVENTION

In general, the food-waste has been separated from the general waste and separately collected since the separate waste collection system has been enforced. The food-waste contains moisture, which causes decay, smell and sanitary issues. Many drying techniques have been developed to treat the above issues. Most drying techniques are focused to a research having an approach such as hot-wind warm air drying, grinding, fermentation. These approaches take an average time of four hours to 20 hours to dry the food-waste once. The food-waste disposal receives worldwide attention. In particular, in Korea, a policy has been operated to charge a fee per food-waste weight by regional group. In Japan, an effort to reduce the food-waste has been made by using a bio-drying technique. Meanwhile, in the United States, the food-waste grinds while passing through a sink before discharging the food-waste to a drain.

However, the above described approaches may arouse an issue to clog the drain in an environment of a large amount of the food waste and high housing density.

### SUMMARY OF THE INVENTION

In view of the above, the present invention provides a volume-rate food-waste disposal apparatus which quickly dries food-waste with a wireless power and provides an on-line charging service.

In accordance with an aspect of the present invention, there is provided a volume-rate food-waste disposal apparatus, which includes: a user recognition unit configured to recognize a user who discharges food-waste into the food-waste apparatus to produce source information; a weight measuring unit configured to measure a weight of the food-waste to produce weight information; a power supply unit configured to receive an electrical power from an exterior power feeder in a wireless manner; a drying unit configured to dry the food-waste with magnetic waves; and a communication unit configured to transmit the source information and the source information to a charging server so that an on-line food-waste disposal fee per source is billed on a basis of a prefixed food-waste disposal fee per weight.

The user recognition unit may recognize the user using RFID tag or NFC (Near Field Communication) technique.

The power supply unit may be supplied with the electrical power through the use of an inductive coupling or a resonant coupling from the exterior power feeder.

The exterior power feeder may supply the electrical power from a regenerative energy or a commercial power.

The drying unit may dry the food-waste using microwaves.

The drying unit may include a structure of a coupled transmission line which generates electric fields of the microwaves in a space where the food-waste is stored.

The drying unit may include a waveguide structure designed to operate at higher mode.

In accordance with another aspect of the present invention, there is provided a charging apparatus, which includes: a receiving unit configured to communicate with a volume-rate food-waste disposal apparatus and receive source information indicative of a source who discharges food-waste and weight information indicative of a weight of the discharged food-waste; a calculation unit configured to calculate a volume-rated food-waste disposal fee of the discharged food-waste depending on a prefixed food-waste disposal fee per weight; and a billing unit configured to produce a fee per source based on the calculated volume-rated food-waste disposal fee and the source information, thereby billing the user who discharges the food-waste for the fee per source.

The billing unit may provide information on the fee per source to the volume-rate food-waste disposal apparatus in real-time.

In accordance with the present invention, the food-waste discharged from an apartment complex or households can quickly dry using a wireless power, and the volume-rate food-waste disposal fee can be billed on-line.

### BRIEF DESCRIPTION OF THE DRAWINGS

The above and other objects and features of the present invention will become apparent from the following description of the embodiments given in conjunction with the accompanying drawings, in which:

FIG. 1 illustrates a schematic block diagram of a volume-rate food-waste disposal system in accordance with an exemplary embodiment of the present invention;

FIG. 2 illustrates a volume-rate food-waste disposal apparatus in accordance with an exemplary embodiment of the present invention;

FIG. 3 is a schematic diagram illustrating a structure of a coupled transmission line;

FIG. 4 is a schematic diagram illustrating a structure of a waveguide; and

FIG. 5 is a schematic block diagram of a charging server in accordance with an exemplary embodiment of the present invention.

### DETAILED DESCRIPTION OF THE EMBODIMENTS

Detailed description of the present invention will be described below with reference to the accompanying drawings illustrating specific embodiments of the present invention. These embodiments are described in detail so that those skilled in the art can easily practice the present invention. It should be understood that various embodiments of the present invention are different from each other, but need not be mutually exclusive. For example, a particular shape, structure and properties that are described herein and are related to one embodiment of the present invention may be implemented with other embodiments without departing the scope of the present invention. Further, it should be understood that the position and arrangement of the individual components in the embodiments may be changed without departing the scope of the present invention. Therefore, the detailed description below is rather than those that try to take as a limiting sense if it is explained properly, the scope of the present invention is only limited by all ranges identical to those that it claims, but the appended claims similar reference numerals refer to the same or similar elements throughout the drawings.

Hereinafter, embodiments of the present invention will be described in detail with reference to the accompanying drawings so that they can be readily implemented by those skilled in the art.

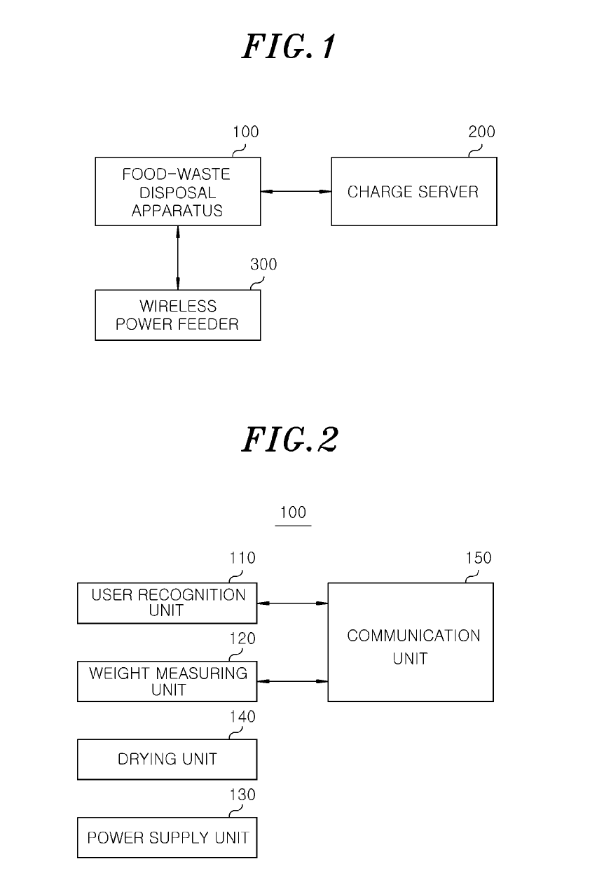

FIG. 1 illustrates a schematic block diagram of a volume-rate food-waste disposal system in accordance with an exemplary embodiment of the present invention.

Referring to FIG. 1, a volume-rate food-waste disposal system of an exemplary embodiment includes a volume-rate food-waste disposal apparatus 100, a charging server 200, and a power feeder 300.

The food-waste disposal apparatus 100 communicates with the charging server 200 and sends information on a source which discharges food waste and a weight of the discharged food-waste to the charging server 200. The source information includes an identifier for individuals or households.

The charging server 200 collects information on the sources and weights for analyzing thereof to produce charging information for billing a fee per source discharging the food-waste in compliance with a predetermined weight-based fee system. The charging server 200 provides information on the volume-rate food-waste fee through the use of the charging information to bill the individuals or the households for the volume-rate food-waste disposal fee.

The power feeder 300 supplies an electric power to the food-waste disposal apparatus 200 using a regenerative power or a commercial power. The regenerative power refers to an electric power converted from an environmental energy into an electrical energy, and the commercial power refers to an electric power available from an electric power company. The power feeder may include an Energy Harvest module which converts an environmental energy into an electrical energy. The environmental energy may include a photovoltaic energy or the like. Further, it is preferable for the power feeder 300 to supply the regenerative power or the commercial power to the food-waste disposal apparatus in a wireless manner. To do it, a wireless power transmission technique may be employed. More specifically, the wireless power transmission technique may take an inductive coupling based on an electromagnetic induction phoneme or an electromagnetic resonance coupling based on an electromagnetic resonance phoneme.

The inductive coupling is a technique to transmit an electric power using a primary coil and a secondary coil, wherein a magnetic field changing at one coil due to an electromagnetic induction phoneme induces current in the other coil so that the electric power is transmitted. For example, in a case where the power feeder 300 has a primary coil and the food-waste disposal apparatus has a secondary coil, the coupling between the power feeder 300 and the food-waste disposal apparatus 200 causes the supply of the electric power to the food-waste disposal apparatus 100.

The resonance coupling is a technique causing resonance in the food-waste disposal apparatus 100 by the wireless power signal sent from the power feeder 300. Such a resonance enables the power feeder 300 to achieve the supply of the power to the food-waste disposal apparatus 200. In general, the inductive coupling is applicable to a close distance ranging several tens of cm or fewer, and the resonant coupling is applicable to a long distance ranging several tens of cm or more.

The embodiments of the present invention are not limited to the above description and may utilize a rechargeable battery to supply an electrical power to the food-waste disposal apparatus 300. As described above, the power feeder 300 supplies an electrical power to the food-waste disposal apparatus 200 in a wireless manner, which gives the food-waste disposal apparatus freely movable. Furthermore, when the food-waste dried in the food-waste disposal apparatus 200 is collected by a food-waste collection vehicle, there is no need to unplug the food-waste disposal apparatus 200 and a short circuit due to the moisture of the food-waste can be prevented.

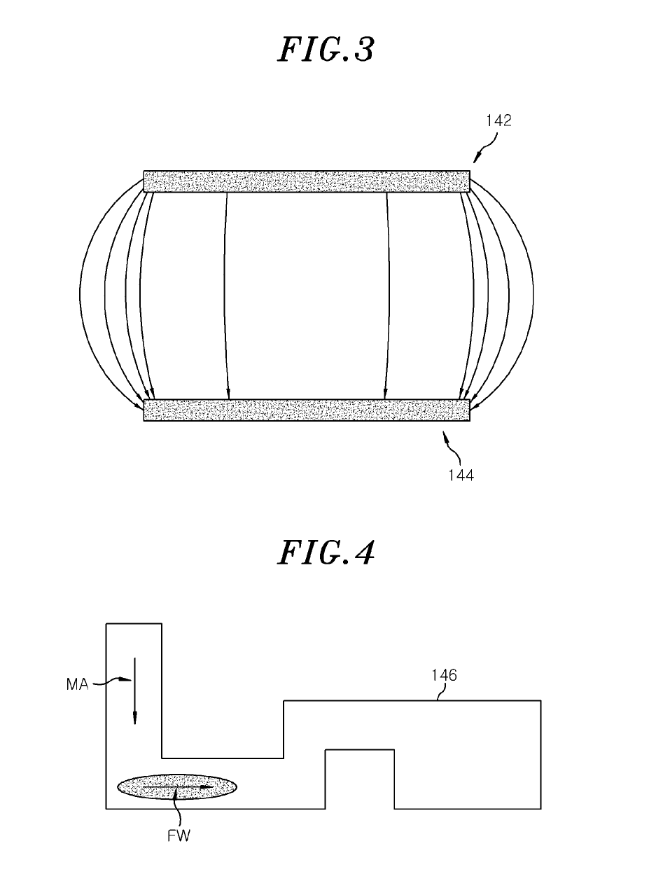

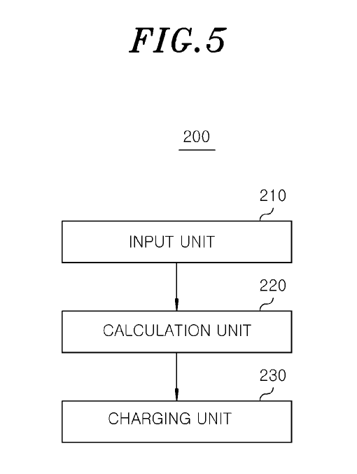

FIG. 2 is a block diagram of the food-waste disposal apparatus in accordance with an exemplary embodiment of the present invention, FIG. 3 is a diagram illustrating a structure of a coupling waveguide and FIG. 4 is a diagram illustrating a structure of a waveguide.

Referring to FIG. 2, the food-waste disposal apparatus 100 in accordance with an exemplary embodiment includes a user recognition unit 110, a weight measuring unit 120, a power unit 130, a drying unit 140, and a communication unit 150.

The user recognition unit 110 is in charge of recognizing individuals or households that discharge the food-waste to create source information. The recognition of the individual or households may be achieved using an RFID (Radio Frequency Identification) tag or NFC (near field communication) technique. The individuals or the households need to provide with their identification cards for recognition in advance. The identification cards are registered in advance in the user recognition unit 110. The user recognition unit 110 recognizes who is a user to dispose the food-waste and admits the user to put the food-waste. Further, the user recognition unit 110 may have an input window through which a user directly input his/her identification information. In addition, the user recognition unit 110 may have a display unit to display an indication of the food-waste input completion or information on the measured weight of the food-waste.

The weight measuring unit 120 is used to measure the weight of the food-waste to produce weight information. The weight measuring unit 120 may be embodied with a scale such as an electronic scale. The power supply unit 130 runs off the power feeder 300.

The drying unit 140 is responsible for providing a fast drying capability. It is preferable to design the drying unit 140 to dry the food-waste using electromagnetic waves. In this case, the electromagnetic waves may include a microwave, ultra-red ray, visible lay, or the like. An exemplary embodiment where the drying unit 110 dries the food-waste using the microwave will be described as follows.

The drying unit 140 emits the microwave toward a space where the food-waste is stored so that the moisture and dielectric contained in the food-waste can be heated by the microwave. Since the microwave is created mainly by an electric field, the drying unit 140 needs to have a structure in which electric fields are uniformly widely distributed over the space.

To do it, the drying unit 140 has a structure of a coupled transmission line. Such a coupled transmission line enables the distribution of a considerable amount of the electric fields over a particular space while offsetting magnetic fields, thereby increasing an electric field twice. As shown in FIG. 3, the coupled transmission line includes two inner plates 142 and 144 located to face each other. The two plates 142 and 144 are electrically connected with an oscillator (not shown) for generating microwaves. The ends of the plates 142 and 144 are opened or short-circuited, a power supplying unit for supplying power to the oscillator forms an isolator, and a standing wave is induced within the coupled transmission line.

Meanwhile, the drying unit 140 of the embodiment may have a form of a slit antenna structure. The slit antenna structure has a plurality of slits formed in the coupled transmission line so that the electric fields can be uniformly formed in the particular space. Further, the drying unit 140 may have a form of a waveguide structure. In this case, it is preferable that the waveguide structure is designed to have uniform electric fields formed in the waveguide by modulating the operating frequency and size of the waveguide and taking a higher mode with stirrers arranging in the waveguide. Accordingly, as shown in FIG. 4, when the food-waste (FW) is put into the waveguide, the microwaves (MA) cause the movement of electromagnetic waves along the waveguide, thereby drying the food-waste.

The communication unit 150 communicates with the charging server 200, transmits the source information and weight information to the charging server 200 and receives charging information per source.

FIG. 5 is a schematic block diagram of the charging server in accordance with an exemplary embodiment of the present invention.

Referring to FIG. 5, the charging server 200 of the embodiment includes an input unit 210, a calculation unit 220, and a charging unit 230. The input unit 210 communicates with the food-waste disposal apparatus 100 and receives the source information indicative of a user who discharges the food-waste and the weight information on the discharged food-waste. In accordance with the embodiment, it is preferred that the communication between the input unit 210 and the food-waste disposal apparatus 100 is made in a wireless manner.

The calculation unit 220 calculates a volume-rate food-waste disposal fee by applying a prefixed fee per weight to the weight information. The charging unit 230 pairs the calculated volume-rate food-waste disposal fee and the source information to produce the charging information per source, and bills an individual or a household who discharges the food-waste for the volume-rate food-waste disposal fee. The charging information on a basis of a source may be sent from the charging unit 230 to the food-waste disposal apparatus 100 in real-time. In addition, the charging unit 230 may bill an individual or a household who discharges the food-waste for the volume-rate food-waste disposal fee which is accumulated for a predetermined time period.

As described above, the food-waste disposal apparatus and the charging apparatus for use with the same uses the magnetic waves to make dry the food-waste with a high speed and low power and provides an on-line charging service to bill a user for the volume-rate food-waste disposal fee. Accordingly, it is possible to get and analyze the charging information in real-time and facilitates a charging and operation. Further, the present invention implements a hybrid power supply using the wireless power transmission technique and thus can overcome the restriction in a location where the food-waste disposal apparatus is installed.

While the invention has been shown and described with respect to the preferred embodiments, the present invention is not limited thereto. It will be understood by those skilled in the art that various changes and modifications may be made without departing from the scope of the invention as defined in the following claims.

What is claimed is:

1. A volume-rate food-waste disposal apparatus comprises:
a user recognition unit configured to recognize a user who discharges food-waste into the food-waste apparatus to produce source information;
a weight measuring unit configured to measure a weight of the food-waste to produce weight information;
a power supply unit configured to receive an electrical power from an exterior power feeder in a wireless manner;
a drying unit configured to dry the food-waste with magnetic waves; and
a communication unit configured to transmit the source information and the source information a charging server so that an on-line food-waste disposal fee per source is billed on a basis of a prefixed food-waste disposal fee per weight.

2. The volume-rate food-waste disposal apparatus of claim 1, wherein the user recognition unit recognizes the user using RFID tag or NFC (Near Field Communication) technique.

3. The volume-rate food-waste disposal apparatus of claim 1, wherein the power supply unit is supplied with the electrical power through the use of an inductive coupling or a resonant coupling from the exterior power feeder.

4. The volume-rate food-waste disposal apparatus of claim 1, wherein the exterior power feeder supplies the electrical power from a regenerative energy or a commercial power.

5. The volume-rate food-waste disposal apparatus of claim 1, wherein the drying unit dries the food-waste using microwaves.

6. The volume-rate food-waste disposal apparatus of claim 1, wherein the drying unit comprises a structure of a coupled transmission line which generates electric fields of the microwaves in a space where the food-waste is stored.

7. The volume-rate food-waste disposal apparatus of claim 1, wherein the drying unit comprises a waveguide structure designed to operate at higher mode.

8. A charging apparatus comprises:
a receiving unit configured to communicate with a volume-rate food-waste disposal apparatus and receive source information indicative of a source that discharges food-waste and weight information indicative of a weight of the discharged food-waste;
a calculation unit configured to calculate a volume-rated food-waste disposal fee of the discharged food-waste depending on a prefixed food-waste disposal fee per weight; and
a billing unit configured to produce a fee per source based on the calculated volume-rated food-waste disposal fee and the source information, thereby billing the user who discharges the food-waste for the fee per source.

9. The charging server of claim 8, wherein the billing unit provides information on the fee per source to the volume-rate food-waste disposal apparatus in real-time.
